(19) United States
(12) Patent Application Publication
(10) Pub. No.: US 2021/0073688 A1
(43) Pub. Date: Mar. 11, 2021

(54) SYSTEM AND PROCESS FOR DELIVERING TICKETS TO AIRCRAFT TRAVELERS

(71) Applicant: Airbus SAS, Blagnac (FR)

(72) Inventors: Elise Weber, Blagnac (FR); Matthew Tringham, Blagnac (FR)

(21) Appl. No.: 17/101,365

(22) Filed: Nov. 23, 2020

Related U.S. Application Data
(63) Continuation-in-part of application No. PCT/EP2019/069154, filed on Jul. 16, 2019.
(60) Provisional application No. 62/700,023, filed on Jul. 18, 2018.

(51) Int. Cl. G06Q 10/02; G06Q 30/02

(52) U.S. Cl. CPC G06Q 10/025; G06Q 30/0282; G06Q 30/0284

(57) ABSTRACT

A method and system for providing tickets to aircraft travelers. A traveler inputs route criteria, a database stores an amount of risk accumulated, a database stores an amount of contracts acquired, a module calculates a risk difference between said amounts, a module determines a time window of flexibility for each ticket intended to be sold to travelers, a module determines tickets to which a flexibility can be offered, a module determines prices of contracts, a module determines prices of tickets, a module calculates a total price of tickets, and a module displays at least the prices of tickets and the prices of flexibility attached to the tickets. Once the traveler has inputted the selected ticket to purchase, the ticket is provided to the traveler. The ticket may be a paper ticket, an electronic ticket, a ticket with flexibility, or a non-flexible ticket.

### RELATED APPLICATIONS

This application is a continuation-in-part of International Application No. PCT/EP2019/069154 filed on Jul. 16, 2019 and which claims priority to U.S. Appl. Ser. No. 62/700,023 filed on Jul. 18, 2018, the entireties of both of which are hereby incorporated by reference.

### TECHNICAL FIELD

The present disclosure relates to a system and method for improving the ticketing of aircraft travelers and more particularly to systems and processes which deliver a ticket to a traveler.

### BACKGROUND

Airline ticket prices are highly volatile. The drivers of this volatility are the economic fundamentals of supply and demand, exposure to global risks and the highly competitive nature of the sector.

Moreover, “revenue management” strategies deployed by most airlines are added to the complexity of the situation. “Revenue management” is the active variation of the prices offered to travelers by airlines to optimize the filling of the aircraft at the best price. The most basic way to understand “revenue management” can be as follows: when tickets for a specific flight are commercialized, they are commercialized at a discount. As the number of tickets sold increases and the closer the date of travel, the more the price of the tickets on sale increases.

The success of this approach is predicated on the fact that tickets are not flexible, fungible, or transferable without the traveler paying significant fees or indeed buying a significantly more expensive ticket in the first place. Accordingly, by following this approach, the airlines act to minimize the risks of not filling the aircraft. However, this makes the travel booking and ticketing procedure inconvenient for the travelers as they have less flexibility than they could have if they would use other means of transport.

### SUMMARY

A purpose of the present disclosure is to overcome this disadvantage by proposing a system and method for improving the ticketing of aircraft travelers to allow for flexibility in the tickets that are delivered to the travelers.

For this purpose, the disclosure herein relates to system for improving the ticketing of aircraft travelers.

According to one or more aspects of the disclosure herein, the present invention may be characterized as providing a system having:

an input module configured to input by a traveler route criteria including at least departure location criteria, destination location criteria, and travel criteria and configured to deliver a purchased ticket in response to input;

a first database configured to store a first amount representative of risk accumulated by an operator; a second database configured to store a second amount representative of contracts acquired by the operator;

a first calculating module configured to calculate a risk difference between the first amount and the second amount, each of the contracts defining a flexibility of a ticket;

a first determining module configured to determine a time window of flexibility for each ticket intended to be sold to a traveler according to a first set or sets of rules, the first set or sets of rules being determined from airline ticket inventory source or sources and from inventory model source or sources;

a second determining module configured to determine ticket or tickets to which a flexibility can be offered according to a second set or sets of rules;

a third determining module configured to determine prices of contracts according to contract transaction data sources;

a fourth determining module configured to determine prices of tickets according to ticket transaction data sources;

a second calculating module configured to calculate a total price of tickets corresponding to the operator route criteria, the total price comprising the prices of tickets and the prices of the flexibility attached to tickets corresponding to routes found according to the route criteria, the price of flexibility being calculated from at least the risk difference, the first set or sets of rules, the second set or sets of rules and prices of contracts;

a display module configured to display at least the prices of tickets and the prices of flexibility attached to the tickets calculated by the second calculating module.

Thus, thanks to the present method, the ticketing of aircraft travelers is improved by providing flexibility to the traveler without disadvantaging the operator.

Moreover, the system may include a contract ordering module configured to increase or decrease the second amount according to a predetermined threshold of the risk difference, the second amount being increased by transferring an amount of contract or contracts from a standardized contracts source or sources to the second database, the second amount being decreased by transferring an amount of contract of contracts from the second database to the standardized contracts source or sources.

In a preferred embodiment, the fourth determining module includes:

a first transceiver configured to receive a plurality of datasets from the ticket transaction data sources, the plurality of datasets including at least a first dataset and a second dataset that are received, respectively, from different ones of the plurality of different ticket transaction data sources, the first dataset including records of data of prices being offered on the market to buy tickets and the second dataset including records of data of transactions of tickets;

a first non-transitory computer readable storage medium configured to store a third database;

a first processing unit that includes at least one hardware processor, the first processing unit being configured to:
store, to the third database, the received plurality of datasets;
generate a first record-level integrated dataset by:
   for each corresponding record of a plurality of records from the second dataset, search the first dataset to locate at least one record that is used to match with the corresponding record from the second dataset, and
   populate the first record-level integrated dataset with a combination of data from the corresponding record of the second dataset and the located at least one record from the first dataset;
generate at least one first index dataset based on the first record-level integrated dataset; and
transmit, via the first transceiver, the generated at least one first index dataset for reception by the second calculating module.

According to one feature, search of the first dataset to locate at least one record is further based on ranking a plurality of records from the first dataset according to matching criteria.

According to another feature, the located at least one record in the first dataset is located based on having the highest rank according to the matching criteria.

Moreover, the matching criteria take into account one or more of the traveler route criteria.

Besides, records in the first and/or second dataset that are not matched are excluded from the first record-level integrated dataset.

Furthermore, based on locating multiple records in the first dataset that a corresponding record may match to, calculate average price data is based on a pricing data from each record in the multiple records, the average price data being combined with the data of transactions of tickets of the corresponding record into the record-level integrated dataset.

According to a preferred embodiment, the third determining module includes:

a second transceiver configured to receive a plurality of datasets from the contract transaction data sources, the plurality of datasets including at least a third dataset and a fourth dataset that are received, respectively, from different ones of the plurality of different contract transaction data sources, the third dataset including records of data of average prices for all standardized contacts since an initiation of said system and the fourth dataset including records of data of current bid and offer price for each type of standardized contract;

a second non-transitory computer readable storage medium configured to store a fourth database;

a second processing unit that includes at least one second hardware processor, the second processing unit being configured to:
store, to the fourth database, the received plurality of datasets;
generate at least one second index dataset based on the plurality of datasets; and
transmit, via the second transceiver, the generated at least one second index dataset for reception by the second calculating module.

According to one feature, search of the third dataset to locate at least one record is further based on ranking a plurality of records from the third dataset according to matching criteria.

According to another feature, the located at least one record in the third dataset is located based on having the highest rank according to the matching criteria.

Moreover, the matching criteria take into account one or more of the traveler route criteria.

Besides, records in the third and/or fourth dataset that are not matched are excluded from the second record-level integrated dataset.

Furthermore, based on locating multiple records in the third dataset that a corresponding record may match to, calculate average price data based on a pricing data from each record in the multiple records, the average price data is combined with the data of transactions of contacts of the corresponding record into the second record-level integrated dataset.

In another aspect, the present invention may be generally characterized as providing a method for providing tickets to aircraft travelers by: receiving, via an input module, route criteria inputted by a traveler, the route criteria including at least departure location criteria, destination location criteria and travel criteria; storing, in a first database, a first amount representative of risk accumulated by an operator; storing, in a second database, a second amount representative of contracts acquired by the operator; calculating, via a first calculating module, a risk difference between the first amount and the second amount; determining, via a first determining module, a time window of flexibility for each ticket intended to be sold to a traveler according to a first set or sets of rules, the first set or sets of rules being determined from airline ticket inventory source or sources and from inventory model source or sources; determining, via a second determining module, one or more tickets having a flexibility is be offered according to a second set or sets of rules; determining, via a third determining module, prices of contracts according to contract transaction data sources; determining, via a fourth determining module, prices of tickets according to ticket transaction data sources; calculating, via a second calculating module, a total price of tickets corresponding to the operator route criteria, the total price comprising the prices of tickets and the prices of the flexibility attached to tickets corresponding to routes found according to the route criteria, the price of flexibility being calculated from at least the risk difference, the first set or sets of rules, the second set or sets of rules, and prices of contracts; displaying, via a display module, at least the prices of tickets and the prices of flexibility attached to the tickets calculated by the second calculating module; and providing a ticket to the traveler in response to a positive purchase request received from the traveler.

The method may also include increasing or decreasing, via a contract ordering module, the second amount according to a predetermined threshold of the risk difference, the second amount being increased by transferring an amount of contract or contracts from a standardized contracts source or sources to the second database, the second amount being decreased by transferring an amount of contract of contracts from the second database to the standardized contracts source or sources.

It is also contemplated that the process includes: receiving, via a first transceiver, a plurality of datasets from the ticket transaction data sources, the plurality of datasets including at least a first dataset and a second dataset that are received, respectively, from different ones of the plurality of different ticket transaction data sources, the first dataset including records of data of prices being offered on the market to buy tickets and the second dataset including records of data of transactions of tickets; storing, in a third database, the received plurality of datasets; generating, via a first processing unit, a first record-level integrated dataset by: for each corresponding record of a plurality of records from the second dataset, search the first dataset to locate at least one record that is used to match with the corresponding record from the second dataset, and populate the first record-level integrated dataset with a combination of data from the corresponding record of the second dataset and the located at least one record from the first dataset. The process also includes generating at least one first index dataset based on the first record-level integrated dataset and transmitting, via the first transceiver, the generated at least one first index dataset for reception by the second calculating module. The search of the first dataset to locate at least one record may include ranking a plurality of records from the first dataset according to matching criteria. The located at least one record in the first dataset may be located based on having the highest rank according to the matching criteria. The matching criteria may take into account one or more of the traveler route criteria. Records in the first dataset, the second dataset or both that are not matched may be excluded from the first record-level integrated dataset. When multiple records in the first dataset that a corresponding record match, the method may include calculating average price data based on a pricing data from each record in the multiple records, the average price data being combined with data of transactions of tickets of the corresponding record into the record-level integrated dataset. The third determining module may include: a second transceiver configured to receive a plurality of datasets from the contract transaction data sources, the plurality of datasets including at least a third dataset and a fourth dataset that are received, respectively, from different ones of the plurality of different contract transaction data sources, the third dataset including records of data of average prices for all standardized contacts since an initiation of said system and the fourth dataset including records of data of current bid and offer price for each type of standardized contract; a second non-transitory computer readable storage medium configured to store a fourth database; and a second processing unit that includes at least one second hardware processor, the second processing unit being configured to: store, to the fourth database, the received plurality of datasets; generate at least one second index dataset based on the plurality of datasets; and transmit, via the second transceiver, the generated at least one second index dataset for reception by the second calculating module. Search of the third dataset to locate at least one record may be based on ranking a plurality of records from the third dataset according to matching criteria. The located at least one record in the third dataset may be located based on having the highest rank according to the matching criteria. The matching criteria may take into account one or more of the traveler route criteria. Records in the third dataset, the fourth dataset, or both that are not matched may be excluded from the second record-level integrated dataset. When multiple records are located in the third dataset that a corresponding record may match to, the method may include calculating average price data based on a pricing data from each record in the multiple records, the average price data being combined with the data of transactions of contacts of the corresponding record into the second record-level integrated dataset.

The ticket provided to the traveler may be a paper ticket or an electronic ticket. Additionally, the ticket provided to the traveler may be a flexible ticket or a non-flexible ticket.

These and other aspects and embodiments of the present invention will be appreciated by those of ordinary skill in the art based upon the following description of the drawings and detailed description of the preferred embodiments.

### BRIEF DESCRIPTION OF THE DRAWINGS

The disclosure herein, with its features and advantages, will emerge more clearly on reading the description given with reference to the appended drawings in which:

FIG. 1 shows schematically a system for providing aircraft tickets used in one or more of the present processes; and,

FIG. 2 shows schematically a module for determining prices of tickets in the present processes.

### DETAILED DESCRIPTION

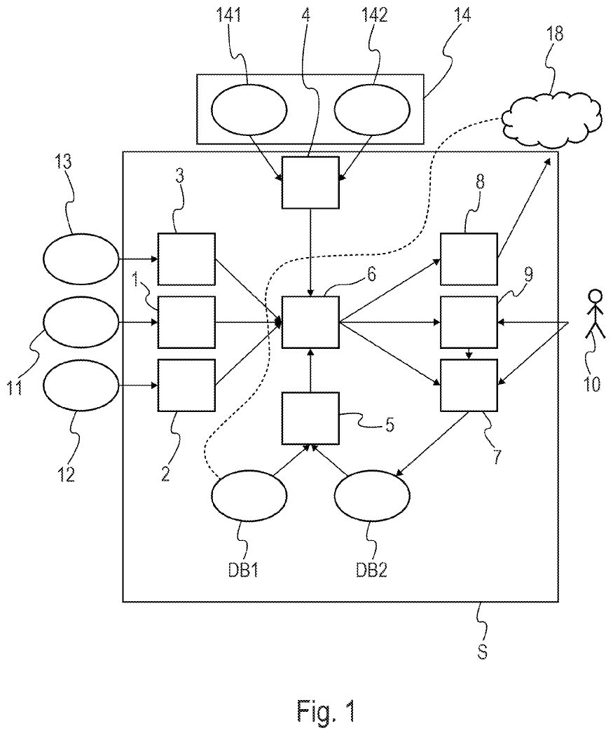

The system S for improving the ticketing of aircraft travelers is shown schematically in FIG. 1. In the rest of the description, said system S will be called “system S”.

The system S comprises an input module 7 configured to receive input by a traveler 10 route criteria including at least departure location criteria, destination location criteria, and travel criteria. Additionally, the input module 7 maya be further configured to receive data or instructions from the traveler relating to the purchase of a ticket which is then provided or delivered by the system S to the traveler.

The system S further comprises a database DB1 configured to store a first amount representative of risk accumulated by an operator (agent or airline company); and a database DB2 configured to store a second amount representative of contracts acquired by the operator. Each of the contracts is attached to a ticket.

The database DB1 then stores data concerning the tickets which flexibility is attached to that are currently unconverted to full tickets that have been purchased by travelers and provided or delivered to the travelers. Data concerning the number of kilometers, the price per kilometer that has been promised to the traveler 10, the routes, the regions are also included. The database DB2 stores data concerning all the open financial contracts held by the operator. Data concerning the strike price for any options, settlement price for any futures, the number of kilometers covered, the regions, the routes and the time windows for which these financial contracts provide coverage.

The first and the second amounts can be given in RPK (Revenue Passenger Kilometers). These amounts are calculated by multiplying the number of revenue-paying passengers aboard the aircraft by the distance travelled.

In this case, the first amount corresponds to the amount of RPK sold in contracts to travelers 10. The second amount corresponds to the amount of RPK held in contracts by the operator.

Each time a traveler 10 is provided with a ticket with flexibility, the first amount increases. Each time the operator acquires a contract, the second amount increases.

The system S further comprises a calculating module 5 configured to calculate a risk difference between the first amount acquired from the database DB1 and the second amount acquired from the database DB2. Then, according to the increase and the decrease of the first amount and the second amount, the risk difference will change. Each time a traveler 10 either is provided with a ticket having flexibility or converts a flexible ticket to an actual ticket the first amount is exposed to changes. For example, when a ticket having flexibility is sold to a traveler 10, the operator is taking on the risk that he will need to buy a ticket at a price which is unknown at some point in the future. Likewise, when a flexible ticket is converted to an actual ticket or cancelled, this risk is removed since an identified amount of money is paid for a ticket or the obligation lapses. This risk can be quantified by considering all the potential tickets as kilometers to be flown (in RPK) on various days in an identified region at an identified price per kilometer that has been guaranteed to a traveler 10. Similarly, at any one moment, the operator will have entered into a number of contracts that will be denominated in RPK for identified regions in identified time windows. These contracts will pay the operator money if prices go above a certain level, hence protecting the operator from the risk that has been accumulated through the sale of flexible tickets. This calculating module 5 compares the quantifications of both in order to output the risk difference.

The system S further comprises:

a determining module 4 configured to determine a time window of flexibility for each ticket intended to be sold to a traveler 10 according to a first set or sets of rules 14;

a determining module 3 configured to determine ticket or tickets to which a flexibility can be offered according to a second set or sets of rules 13;

a determining module 2 configured to determine prices of contracts according to contract transaction data sources 12;

a determining module 1 configured to determine prices of tickets according to ticket transaction data sources 11.

The ticket transaction data sources 11 comprise a first subset of data concerning transactions made to buy, to exchange, or to cancel tickets. They also comprise a second subset of data concerning prices that are being offered on the market to buy tickets. These sources of data can be travel operators (directly or indirectly) or of GDS (Global Distribution System), or indeed a travel agent or other party checking prices offered on airline tickets. These data can be automatically captured from the Internet by “screenscraping” or directly from a travel operator or metasearch engine.

The contract transaction data sources 12 comprise data concerning the transactions of contracts in financial markets where financial contracts are traded. The contracts concern futures, options, or swaps which are settled on the basis of cost of air travel.

The first set or sets of rules 14 are determined from airline ticket inventory source or sources 141 and from inventory model source or sources 142. The airline ticket inventory source or sources 141 comprise data showing the number of tickets a travel operator has available to sell. This data can also include the pricing for specific tickets on specific flights that an operator can sell. The inventory model source or sources 142 comprises the first set or sets of rules 14 including model or models to estimate the number of tickets remaining available on a given route. These models use datasets such as OAG (Official Airline Guide) or Flight Radar24 to estimate the total number of seats available on all airline routes in the world for each scheduled flight. By combining the estimation with sales that an operator has directly made or with the data of the ticket transaction data sources 11, it is possible to estimate the number of tickets available to sell. While the operator selling flexible tickets can obtain protection against variations in the price of tickets through the use of financial contracts, there remains a risk for any operator that no further tickets are available to purchase at the necessary moment for the necessary ticket. For this reason the operator sets either static or dynamic limits to the size of the time window for which flexibility is proposed for any given ticket. Determining module 4 can hold the first set or sets of rules 14 determining for each possible flight condition under which flexibility may be offered (time of year, day of week, booking date, travel date, number of days between booking and travel, etc.). The determining module 4 can output rules that can then be used to prevent or enable offer of flexibility at individual flight level and also at itinerary level (a series of flights offered together). Determining module 4 can be updated regularly to ensure performance either manually following repeated study of market behavior, or mechanically on the fly by continuously evaluating how individual routes are performing versus the regions concerned. For an airline acting as an operator this determining module 4 can interact with the company's existing inventory management system directly to ensure that sufficient capacity is available to cover the flexible ticketing.

The second set or sets of rules 13 are determined from model or models to estimate how the prices and traffic on individual routes or subsets of routes behave with regards to pricing and traffic (number of passengers or total number of kilometers flown) compared to large regions routes. Individual routes can be London to New York, for example. Subsets of routes can be United Kingdom to USA, for example. Large regions routes can be Europe to North America, for example. The second set or sets of rules 13 are intended to ensure that the risk profile of flexibility that has been sold or is offered for sale may be appropriately covered by the contracts that the operator has acquired or may acquire. The inventory model source or sources 142 also comprises a similar set of rules concerning time. The operator will be using a financial contract that is based on average prices in a region over a time period. If the time period is one month for example, the operator will similarly need to spread the sale of flexible tickets throughout the month to make sure that average prices correspond. The second set or sets of rules 13 are updated regularly to ensure performance either manually following repeated study of market behavior, or mechanically on the fly by continuously evaluating how prices on individual routes vary versus the regions concerned. The inputs to get the second set or sets of rules 13 are the minimum number of different routes that need to have flexible tickets sold on, a list of routes that match well to the region average, including how well they match (allowing more tickets to be sold on these routes), a list of routes where the opposite is true (allowing less of these tickets to be sold) and a set of rules stipulating a distribution of flexible tickets through a time window that need to be sold.

The system S also comprises a calculating module 6 configured to calculate a total price of tickets corresponding to the operator route criteria. The total price comprises the prices of tickets and the prices of flexibility attached to tickets corresponding to routes found according to the route criteria. The price of flexibility is calculated from at least the risk difference, the first set or sets of rules 14, the second set or sets of rules 13 and prices of contracts.

The system S includes a display module 9 configured to display the prices of tickets and the prices of flexibility attached to the tickets calculated by the calculating module 6.

For example, the system S allows the display of a webpage on user's computer by the display module 9, for enabling user to input data by the input module 7.

The system S can further comprise a contract ordering module 8 configured to increase or decrease the second amount according to a predetermined threshold of the risk difference. The second amount is increased by transferring an amount of contract or contracts from a standardized contracts source or sources 18 to the database DB2. The second amount is decreased by transferring an amount of contract of contracts from the database DB2 to the standardized contracts source or sources 18.

The standardized contracts source or sources 18 comprise a set of standardized financial derivative contracts of different types, as futures, swaps and options, covering in a standard manner the different air traffic flows in the world (Europe to Europe, North America to Europe, etc.). Likewise, they cover specific time windows and have a standardized lot size which can be in RPK (500,000 RPK, for example). It is expected that there are standardized contracts for each inhabited continent and international route for both premium and economy travel and for each of the upcoming eighteen months, then, one single contract for months eighteen to twenty-four, leading to a total of one thousand and six four (1,064) contracts.

The calculating module 6 controls the overall offer of flexibility on tickets and the pricing thereof. As a starting point, the operator sets target in terms of the amount of risk outstanding uncovered by financial contracts that he can bear at any given time. This target corresponds to the predetermined threshold of the risk difference. The risk difference may vary throughout the day, the week, or the month. For example, the operator may allow the sale of flexible tickets through the morning and then aim to cover the risk through the afternoon reducing the risk difference to as close to zero as possible. The operator may target a constant positive or negative value of the risk difference. The operator may also set a pattern where the system S is initiated with the purchase of a financial contract giving a positive value to the risk difference. Then, the operator may instruct the system S to function and reduce the risk difference to zero by selling flexibility appropriately. The operator of the system S may then choose to buy another financial contract and allow the process to repeat itself Many other modes of operation can also be envisaged. Calculating module 6 regularly calculates the offerability and the price for flexibility on all routes on a planned basis. Depending on computing power and resources, this may be very rapidly meaning that any information sent to the display module 9 is always valid and available for purchase. Otherwise the calculating module 6 will refresh less frequently but will also be interrogated by display module 9 to give an update to the second offer in reaction to a traveler's query. This mode will enable the operator to save on computing power but always be able to instantly show an offer. But this offer will need to be confirmed by calculating module 6 after selection by the traveler 10 using input module 7.

On the basis of the risk difference, calculating module 6 sends instructions to contract ordering module 8 to buy or sell financial contracts based on the objectives for the risk difference threshold that have been set. A trigger for the use of financial contracts to change the risk difference rather than the sale of flexible tickets may be that tickets are not being sold quickly enough. The rate of change for the risk difference would then be lower than a pre-set rate). Based on the value of the risk difference, the calculating module 6 identifies for which routes flexibility may be offered and for what price. Following this, the flexibility offered will be bounded by the outputs of determining module 4. This bounding will be a limiting of the time windows for flexibility offered. For example, flexibility may not be offered for tickets due to take off less than seven days in the future. The flexibility and prices offered can be further adapted based on the outputs of determining module 3, preventing sale on specific routes or dates where tickets have already been sold or perhaps incentivizing the sale by reducing the price. The price of flexibility could be calculated on the basis on the price per kilometer of the risk difference. This is because if prices go above this value the financial contracts held by the operator will compensate them for having to buy expensive tickets. The operator may choose to add a margin to this price either per kilometer or per transaction (i.e. ticket purchase). The operator will also use the inputs from determining modules 1 and 2 to assist in pricing flexibility using the physical market data to ensure prices are reasonable and competitive, and the financial data from determining module 2 to inform pricing if it is likely that a new financial contract will be needed to cover the risk of the flexible ticket. The availability of flexibility for all routes and pricing is then sent to display module 9 for display. The process of calculating module 6 will also be run when an input from input module 7 requests up to date information for a specific route at the specific request of a traveler 10.

The determining module 1 can comprise:

a transceiver 111 configured to receive a plurality of datasets from the ticket transaction data sources 11, the plurality of datasets including at least a first dataset and a second dataset that are received, respectively, from different ones of the plurality of different ticket transaction data sources 11, the first dataset including records of data of prices being offered on the market to buy tickets and the second dataset including records of data of transactions of tickets;

a non-transitory computer readable storage medium 121 configured to store a third database 620; and,

a processing unit 131 that includes at least one hardware process.

The processing unit 131 can be configured to:

store, to the database 620, the received plurality of datasets;

generate a first record-level integrated dataset by:
for each corresponding record of a plurality of records from the second dataset, search the first dataset to locate at least one record that is used to match with the corresponding record from the second dataset, and
populate the first record-level integrated dataset with a combination of data from the corresponding record of the second dataset and the located at least one record from the first dataset;

generate at least one first index dataset based on the first record-level integrated dataset; and

transmit, via the transceiver 111, the generated at least one first index dataset for reception by the calculating module 6.

Search of the first dataset to locate at least one record can be further based on ranking a plurality of records from the first dataset according to matching criteria.

The located at least one record in the first dataset can be located based on having the highest rank according to the matching criteria.

The matching criteria can take into account one or more of the traveler route criteria.

Records in the first and/or second dataset that are not matched can be excluded from the first record-level integrated dataset.

Based on locating multiple records in the first dataset that a corresponding record may match to, calculate average price data can be based on a pricing data from each record in the multiple records or on using a highest ranked match. The average price data can be combined with the data of transactions of tickets of the corresponding record into the record-level integrated dataset.

Likewise, the determining module 2 comprises:

a transceiver configured to receive a plurality of datasets from the contract transaction data sources 12, the plurality of datasets including at least a third dataset and a fourth dataset that are received, respectively, from different ones of the plurality of different contract transaction data sources 12, the third dataset including records of data of average prices for all standardized contacts since an initiation of said system and the fourth dataset including records of data of current bid and offer price for each type of standardized contract;

a non-transitory computer readable storage medium configured to store a database; and,

a processing unit that includes at least one hardware processor.

The processing unit can be configured to:

store, to the database, the received plurality of datasets;

generate at least one second index dataset based on the plurality of datasets; and

transmit, via the second transceiver, the generated at least one second index dataset for reception by the calculating module 6.

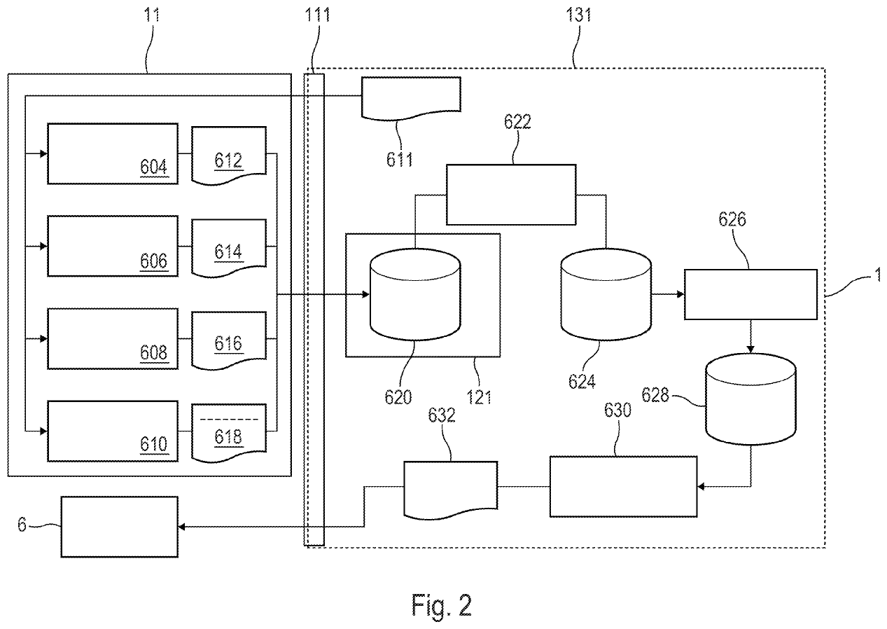

FIG. 2 is a block diagram of an example centralized implementation according to certain example embodiments of the determining module 1. Module 1 communicates with data sources 604-610.

Data sources 604-610 are the ticket transaction data sources 11 for determining module 1. Determining module 1 provides the data sources with a definitions or requirements file 611 that indicates what data is to be provided to module 1. Data sources 604, 606, 608, and 610 also respectively provide datasets 612, 614, 616, and 618 to determining module 1.

In certain examples, data source 604 may be a booking data source (e.g., that provides a dataset on booked tickets), data source 606 may be search data source (e.g., that provides a dataset on searches for tickets), data source 608 may be another searched data source (or an “offered” data source), and data source 610 may be a flown data source (e.g., a dataset on whether the ticket purchase resulted in a person flying for that purchased ticket). Other types of data sources may also be included as they may capture different portions of the booking/travel cycle (e.g., Offered prices, searched prices, booked prices, flown prices) in the air transport industry. In certain example embodiments, datasets 612-618 are provided on a weekly, daily, or intra-daily (e.g., seconds, minutes, hours, etc.) basis.

It will be appreciated that the data provided by the various data sources may overlap one another, contain different information, or measure the same information in a different way (which is addressed via a data cleaning unit 622). The types of parameters that may be included in a provided dataset may include, for example, booking, date of travel, number of passengers, departure airport, arrival airport, transfers, passengers, air fare, taxes, cabin class, service level, etc. In the case where multiple data sources provide the same “type” of information, module 1 may prioritize one data source over another for certain types of information. For example, search data may include accurate pricing information (but without an indication if a booking was actually made). In contrast, the booking or flown data may provide data that a transaction has been made. However, these data sources (e.g., airlines or other) may obscure the actual prices paid for any bookings/flights by replacing the price paid with an “industry average” or other value.

Further the raw data may be collected into database 620 where a data cleaning unit 622 may clean or otherwise perform sanity checks on the data in clean database 624.

A ticket matching engine 626 provides functionality for integrating more accurate pricing information on a ticket level. In other words, data in the search datasets may be combined with data in the booking datasets on a ticket level to create a database with individual ticket data that may more accurately reflect the actual tickets booked (and flown).

Ticket matching engine 626 includes a process that takes all of the bookings and iterates through those bookings looking to match a price from the search dataset for a given booking. In certain examples, if no “good” matches are located then the booking may be discarded. In certain examples, if multiple “good” matches are identified then the best (or average) of the pricing information reflected in the search dataset may be used to generate a new record that is the booking data with the added pricing information.

In more detail, two alternative ticket matching processes could be deployed as follows.

Option 1—Searching for Comparable Tickets

For each booking, a comparison is made to each individual “search” record contained in the search dataset. The quality of match between the booking and the search is given a score. The score is calculated based on the following matching criteria: a) the route flown; b) the time and date that the booking/search was made; c) the booking class and/or cabin; d) the carrier; e) the number of passengers; f) the IP address/city/country/region/of search and/or booking.

Other criteria may also be used. Indeed, there may be tens or hundreds of criteria that factor into the score. Certain types of criteria may also be required to match exactly (e.g., (origin, destination, and carrier as examples) otherwise the match may be deemed invalid. Other criteria will have a sub-score which is used to increase the overall score of the match, for example the closer the time and date of the search is to the booking the higher the sub-score for the time/date aspect of the potential match. In certain examples, if there are no decent matches for a booking it is then excluded from further indexing and may be stored in a separate database. If there are multiple searches that are “good enough” then the match with the highest score is retained. The price from the search is integrated with the rest of the booking data. In certain examples, if there are several good enough matches an average price may be used with a weighting based on the respective scores of the relevant searches.

The following is an example of the above process: Booking A is LHR (London-Heathrow Airport) to JFK (New York-John F. Kennedy Airport), booked on the 1st of April at 19:30, to leave on Friday 5th of May at 17:00 on United flight 626 in premium economy for 2 people with a return flight on the Friday 12th of May. The booking was made from an IP address in London, UK. The flight is direct.

With this booking information, the process then iterates (or otherwise searches) for “good” search results that can match with this book. A first search from LHR to CDG (Paris-Charles de Gaulle Airport) is excluded because the departure/destination does not match the book. A second search is from is for LHR-JFK and on 5th of May but with British Airways (not United). This search is also excluded because the carrier does not match.

A third search matches all criteria but was searched on the 30th of March at 15:00. This search is given a score of 2.

A fourth search also matches all criteria and was searched on the 1st of April at 18:00, it is given a score of 5. The price associated with the search was 500 USD per passenger.

No other matches are identified and accordingly the fourth search is retained, and the price of 500 USD is applied to booking A. In certain examples, the 500 USD may be appended to the booking record. In certain examples, supplemental data may be appended to each booking from a “flown” data source or other type. This data could relate to no-shows, on time departure/arrival . . . or other types of data.

Option 2—Searching for the Same Ticket Offered Bundled or Debundled.

Instead of searching for similar tickets if an exact match is not found, the module 1 looks for itineraries that contain parts of an unmatched ticket and use the prices from these bundles. For example when trying to find a match a ticket to travel from Paris to Chicago via London on the 12th of August at 12:00 with an airline one could look at the price of Paris to London on the same flight (12:00, 12th of August with the airline) and then also at the second flight from London to Chicago and then use the sum of both to estimate the price of Paris-London-Chicago. Exactly the same logic can be applied for more complex itineraries where an estimate of price could be made by combining a 2-leg journey with a 1-leg journey to match a 3-leg ticket. Typically bundled tickets are discounted so in the example of Paris-London-Chicago the sum of the two individual flights would likely be more expensive than the two together. To compensate for this a correction factor can be calculated each day by evaluating itineraries where an exact match has been found and then comparing to the different “matches” made possible by creating the same itinerary out of different components. An example of how this would work is as follows. Module 1 would process both data sets booked and search, finding each exact matched price and combining the appropriate data elements. Next module 1 will look at matches that can be achieved by reconstituting itineraries from smaller elements (for example matching a 3-leg itinerary out of a 2-leg and 1-leg, a 2-leg journey out of 2-leg, 1-leg journeys and so on through all necessary permutations. After this process is complete many tickets will be matched in multiple ways, either exactly or by combining smaller elements. For the itineraries where multiple matches are observed it will be possible to calculate the discount that is applied when multiple legs have been purchased. An average may be taken of this discount and then applied to find a more accurate price for itineraries where an exact match has not been found. In this way multiple prices can be estimated for a given itinerary and the most accurate retained for use. The most accurate being the closest exact match. In a worked example we could consider a four leg itinerary Hamburg-Frankfurt-Beijing-Shanghai-Hamburg, if an exact match was not found the same itinerary could be built out of Hamburg-Frankfurt-Beijing-Shanghai and then another ticket for Shanghai-Hamburg; or indeed Hamburg-Frankfurt-Beijing and Beijing-Shanghai-Hamburg; or even the four individual flights. The closest match in terms of price would likely be the first option 3-legs and then 1-leg. So, this package would be retained as the “best” match. To further improve the quality of the pricing the rest of the derived data set would be checked and the average discount observed between 4-leg itineraries and 3-leg and 1-leg itineraries calculated this “discount factor” could then be applied where needed across the data set. The same logic would be applied to all other potential combinations. In this fashion a similar new data set is created as in option 1 but here every ticket or transaction will have multiple matches, with correction factors where needed, enabling the retention of the “best” price.

Each successfully identified booking/search match may be stored to ticket database 628. Each entry in that database may associate with one more indexes. In the case of the above example, the 2-ticket booking may be split into two separate entries (each with 500 USD) or may be combined into one entry with additional data indicating that it is for two tickets. In any event, this one entry (or multiple) may contribute to one or more indexes. For example, a transatlantic index, an economy transatlantic index, a worldwide long-haul index, a worldwide economy index, etc.

Index generation module 630 may then access the ticket database 628 to calculate, for each index, the average yield (e.g., weighted by RPK or another method). The above examples may “contribute” 2 passengers, 11,000 RPK (2×5,500), and a yield of 9c. In certain examples, other types of data may also be calculated. For example, the following macro data may be calculated (number of passengers, number of RPK overall, total revenue etc.).

The index generation module 630 may perform a sanity check on the indexes and then publish the index via data feed 632 to the calculating module 6. In certain examples, the sanity check may be a manual check or may be automated. For example, a calculated index may be flagged for review if the calculation indicates that the yield is 1c or 0c when the average is 8c. In certain examples, as a function of this sanity checking, publication of the index may be delayed to enable a backup process (e.g., to exclude aberrations, consulting an index committee, etc.).

The system S functions thusly:

1. A prospective traveler 10 searches for a flight via the input module 7 on the website or other platform operated by the operator.

2. The prospective traveler 10 will see a variety of tickets offered via the display module 9, in line with their search. Alongside each ticket offering prices will also be displayed by the display module 9 for the different types of flexibility on the ticket that the operator is willing to sell.

3. The price of the ticket is determined by the price at which the operator is able to acquire the ticket on the open market, any commercial arrangements that the operator has with airlines and their commercial strategy.

4. The price of the flexibility is determined by the calculating module 6 from a variety of inputs to the system S.

5. The type of flexibility (name/date/cancellation for example) is determined by the operator's commercial policy and strategy. The bounds of the flexibility (from the day of reservation until an identified time in the future) are determined by the system S.

6. A typical offer could be as follows: “Agent guarantees to allow passenger G. Jones to buy a ticket from London to Singapore on the 17 Jul. 2019 at 18:00 on British Airways in economy class for 500 GBP. This offer is open until 17 Jun. 2019 and is made in exchange for a payment today 17 January of 50 GBP.” If G. Jones does not confirm his desire for the ticket before 24:00 h on 17 Jun. 2019, the offer will lapse.

7. If the traveler 10 decides to take up the offer from the operator (and thus buying the offered ticket and its flexibility) then a payment will be made by the prospective traveler to the operator using any payment method acceptable to the agent for the flexibility. The operator may also require payment of the ticket itself at this point, but it may decide that this is not necessary. At this point the prospective passenger will also provide all necessary information for the travel agent to execute the agreement. The payment can be made through the input module 7, and the offered ticket will be sold and then provided to the traveler.

8. The operator then updates his record of all risk accumulated and still current through the sale of flexibility. This risk is effectively a manifest of all tickets that the operator may be required to purchase in the future and the associated prices. Of particular interest are the routes, dates, and distances for this potential travel.

9. The system S operated by the operator compares this accumulated risk with the current portfolio of derivative contracts and calculate the risk difference. A typical derivative contract could be of the form “Company X agrees to pay agent Y the difference between 0.15 USD and the average price of travel by aircraft in economy class per km in July 2019 from Europe to Asia. This is for a block of 100,000 km.” Other forms of contract may also be imagined the essence being that company X will pay operator Y money if air travel prices are above a certain threshold, in an identified geographical market for an identified service level within a certain time frame. Operator Y may have paid company X for entering into this contract, or operator Y may agree to pay company X the difference in price if the price of travel is lower than an agreed threshold.

10. As a function of the risk difference between the accumulated risk (tickets that might be bought) and the managed risk (so the sum of the various standard derivative contracts held by the operator), the operator may decide to either automatically or manually buy (enter in to) or sell (exit from) derivative contracts to achieve a predetermined differential. This risk difference may be zero. It is expected that the comparison will be of the following type: 100,000 km of travel between Europe and Asia have been promised at an average price of 0.15 USD per kilometer to ten travelers in July 2019. Current derivatives contracts cover 100,000 km of travel from Europe to Asia in July 2019 and will pay out the difference of price above 0.15 USD. In this example the risk difference is zero.

11. The system S also continuously computes how well the current portfolio of running flexible tickets matches to the portfolio of financial contracts and adapts which routes flexibility is being offered for. The operator may even discount flexibility on certain routes to encourage uptake keeping the portfolio balanced. For example, it could be that at a certain moment that sufficient risk coverage in terms of kilometers has been put in place. For example: 90,000 km in Europe are covered by a derivative contract for 100,000 km but the 90,000 km sold flexibility are skewed towards Western Europe, so the operator may choose to prioritize sales of flexibility on eastern European routes.

12. When setting the price for tickets offered and associated flexibility the system S draws in information from the physical and financial markets as well as the current financial position of the operator. The system S uses these different sets of information to set the prices offered.

13. The flexibility offered is also bounded in time (say flexibility stops one month before travel). The setting of these bounds may be static (i.e. predetermined for each and every route) or dynamic (i.e. it may change depending on how many tickets remain to be sold on a given route or the current pricing).

From the point of view of the traveler 10, the system S can be used as follows:

1. The traveler 10 searches for flight from London to New York in economy class on the 1st of Jun. 2019 with a return on the 8th of Jun. 2019, it is today the 1st of April on a known meta search website via the input module 7.

2. The traveler 10 can see a number of results several of which will be from an agent operating this system. They will be shown with a price, for example 400 USD with a flag showing they can be bought flexibly.

3. The traveler 10 clicks on a specific flight at 12:00 on the 1st of June from LHR with British Airways to JFK and a return at 16:00 on the 8th of June. The traveler 10 is also shown that for 40 USD, he can reserve a ticket at 400 USD for this flight that he only needs to confirm two weeks before the date of travel. He would need to pay 40 USD immediately and then 400 USD when the ticket is purchased definitively. He may buy the ticket definitively up until the time limit of two weeks before travel (17th of May).

4. The traveler 10 selects this ticket and pays 40 USD, and thus the flexible ticket is sold.

5. Three weeks before the date of travel the traveler decides that he definitely wants to use the ticket and reconnect to input module 7 through the agent's website and choose to definitively acquire the ticket.

6. The traveler 10 pays the 400 USD remaining through the input module 7 and is delivered a full ticket to travel on the desired flight. The full ticket (and/or the flexible ticket) may be electronically delivered, physically delivered, or a combination thereof.

The traveler 10 could have chosen to let the choice of the full ticket lapse and bought nothing He could have been obliged to pay up the full 440 USD and then received a reimbursement if cancelled. The flexible ticket could automatically be transformed into an actual ticket at the agreed date with no action from the traveler 10. In such a case, a new ticket may be delivered, or the original ticket may be associated with the actual/non-flexible ticket and no second ticket needs to be delivered for the traveler to board the aircraft. These are not materially different ways of working.

From the point of view of the agent, the system S can be used as follows:

1. The agent initiates the system S by choosing to buy a financial contract for 500,000 RPK that can pay the agent the difference between the average price per RPK of flights between Europe and North America in June 2019 and 0.03 USD (so if the average price is 0.04 cents then the agent will receive 5,000 USD, if the price is 0.02 USD the agent will receive nothing) The contract costs 1,000 USD to acquire.

2. This creates a value for risk difference of 500,000 RPK, from 1st June to 30th of June at 0.03 USD as soon as calculating module 5 is run.

3. Determining module 4 is initiated and is set to limit flexibility sold, so that all flexible tickets sold must be converted to actual tickets no less than two weeks before the date of travel for all flights transiting London, Paris, New York, Atlanta and Frankfurt. All other tickets may have flexibility up until three weeks before the date of travel.

4. Determining module 3 is initiated and set to allow the portfolio of flexible tickets for Europe to North America to contain 10% each from London, Paris, New York, Atlanta, and Frankfurt. All other destinations may have a maximum of 2% each. So, out of hundred tickets sold ten may be from London, but only two may be from Madrid. Determining module 3 is set to allow the sale of a maximum of 4% flexible ticket on any given day in each month.

5. Calculating module 6 is run, as no flexible tickets have been sold flexibility is offered on all flights between Europe and North. America. Based on the inputs from determining modules 1 and 2 all prices for all potential routes are calculated and, specifically in the example, it is calculated that the ticket shown to the traveler 10 for London to New York could have flexibility offered for 40 USD as typically prices will increase by 5% between the 1st of April and 17th of June based on past behavior. Indeed, this would then be the equivalent of 0.03 USD per kilometer for the ticket in question.

6. The financial contract held by the agent will protect around hundred tickets on average to part of the cost of this contract 1,000/100=10 USD is added onto the flexible ticket price, making it 30 USD. The agent then adds a 33% margin to the ticket, making the final flexibility price at 40 USD.

7. This specific ticket and all others are sent for display in the shop window by the display module 9.

8. As described previously the traveler 10 selects the London-New York ticket from the shop window at the display module 9 and the ticket is provided to the traveler. As would be appreciated, paper tickets may be mailed to travelers, or electronic tickets may be emailed or provided via applications or “apps” on smart devices like a smart phone or a tablet.

9. The data from the traveler is input to input module 7 and the value for the risk difference is updated appropriately.

10. Calculating module 6 then updates the shop window accordingly. In this case, there is no difference as the agent is willing to sell up to ten tickets from London (10%) up to four tickets on any given day (4%) and the inputs from the determining modules 1 and 2 have not actually changed.

11. When the traveler 10 decides to change the flexible ticket to an actual ticket, the agent buys the appropriate ticket, and the non-flexible ticket is provided to the traveler. In this case, the ticket costs 430 USD, which is 10 USD more than expected. Indeed, over the whole market, tickets were on average slightly more expensive by the equivalent of 0.002 USD more.

12. The agent buys the ticket nonetheless and the financial contract also pays the agent 1,000 USD due to the higher average price. This gives an average of 10 USD to the agent per ticket sold, makes up the difference in the final price of the ticket sold and protects the agent's margin.

13. To stop the system the agent would simply stop acquiring financial contracts and stop selling flexibility once the risk difference has been reduced to zero.

The systems and devices described herein may include a controller or a computing device comprising a processing unit and a memory which has stored therein computer-executable instructions for implementing the processes described herein. The processing unit may comprise any suitable devices configured to cause a series of steps to be performed so as to implement the method such that instructions, when executed by the computing device or other programmable apparatus, may cause the functions/acts/steps specified in the methods described herein to be executed. The processing unit may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory may be any suitable known or other machine-readable storage medium. The memory may comprise non-transitory computer readable storage medium such as, for example, but not limited to, an electronic, magnetic, optical, electromagnetic, infrared, or semiconductor system, apparatus, or device, or any suitable combination of the foregoing. The memory may include a suitable combination of any type of computer memory that is located either internally or externally to the device such as, for example, random-access memory (RAM), read-only memory (ROM), compact disc read-only memory (CD-ROM), electro-optical memory, magneto-optical memory, erasable programmable read-only memory (EPROM), and electrically-erasable programmable read-only memory (EEPROM), Ferroelectric RAM (FRAM) or the like. The memory may comprise any storage means (e.g., devices) suitable for retrievably storing the computer-executable instructions executable by processing unit.

The methods and systems described herein may be implemented in a high-level procedural or object-oriented programming or scripting language, or a combination thereof, to communicate with or assist in the operation of the controller or computing device. Alternatively, the methods and systems described herein may be implemented in assembly or machine language. The language may be a compiled or interpreted language. Program code for implementing the methods and systems described herein may be stored on the storage media or the device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein.

Computer-executable instructions may be in many forms, including program modules, executed by one or more computers or other devices. Generally, program modules include routines, programs, objects, components, data structures, etc., that perform particular tasks or implement particular abstract data types. Typically, the functionality of the program modules may be combined or distributed as desired in various embodiments. Accordingly, the use of the term module includes software modules wherein “module” refers to instructions stored in non-transitory computer readable storage medium that are implemented by a general computer or processor. Similarly, the use of the term module includes a piece of hardware that includes instructions stored in non-transitory computer readable storage medium that are implemented by a specific computer or processor to the module.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A method for providing tickets to aircraft travelers, the method comprising:
receiving, via an input module, route criteria inputted by a traveler, the route criteria including at least departure location criteria, destination location criteria and travel criteria;
storing, in a first database, a first amount representative of risk accumulated by an operator;
storing, in a second database, a second amount representative of contracts acquired by the operator;
calculating, via a first calculating module, a risk difference between the first amount and the second amount;
determining, via a first determining module, a time window of flexibility for each ticket intended to be sold to a traveler according to a first set or sets of rules, the first set or sets of rules being determined from airline ticket inventory source or sources and from inventory model source or sources;
determining, via a second determining module, one or more tickets having a flexibility is be offered according to a second set or sets of rules;
determining, via a third determining module, prices of contracts according to contract transaction data sources;
determining, via a fourth determining module, prices of tickets according to ticket transaction data sources;
calculating, via a second calculating module, a total price of tickets corresponding to the operator route criteria, the total price comprising the prices of tickets and the prices of the flexibility attached to tickets corresponding to routes found according to the route criteria, the price of flexibility being calculated from at least the risk difference, the first set or sets of rules, the second set or sets of rules, and prices of contracts;
displaying, via a display module, at least the prices of tickets and the prices of flexibility attached to the tickets calculated by the second calculating module; and
providing a ticket to the traveler in response to a positive purchase request received from the traveler.

2. The method of claim 1, further comprising:
increasing or decreasing, via a contract ordering module, the second amount according to a predetermined threshold of the risk difference, the second amount being increased by transferring an amount of contract or contracts from a standardized contracts source or sources to the second database, the second amount being decreased by transferring an amount of contract of contracts from the second database to the standardized contracts source or sources.

3. The method of claim 1, further comprising:
receiving, via a first transceiver, a plurality of datasets from the ticket transaction data sources, the plurality of datasets including at least a first dataset and a second dataset that are received, respectively, from different ones of the plurality of different ticket transaction data sources, the first dataset including records of data of prices being offered on the market to buy tickets and the second dataset including records of data of transactions of tickets;
storing, in a third database, the received plurality of datasets,
generating, via a first processing unit, a first record-level integrated dataset by:
for each corresponding record of a plurality of records from the second dataset, search the first dataset to locate at least one record that is used to match with the corresponding record from the second dataset, and
populate the first record-level integrated dataset with a combination of data from the corresponding record of the second dataset and the located at least one record from the first dataset;
generating at least one first index dataset based on the first record-level integrated dataset; and
transmitting, via the first transceiver, the generated at least one first index dataset for reception by the second calculating module.

4. The method of claim 3, wherein the search of the first dataset to locate at least one record includes ranking a plurality of records from the first dataset according to matching criteria.

5. The method of claim 4, wherein the located at least one record in the first dataset is located based on having a highest rank according to the matching criteria.

6. The method of claim 4, wherein the matching criteria take into account one or more of the traveler route criteria.

7. The method of claim 3, wherein records in the first dataset, the second dataset or both that are not matched are excluded from the first record-level integrated dataset.

8. The method of claim 3, wherein when multiple records in the first dataset that a corresponding record matches, the method further includes:
calculating average price data based on a pricing data from each record in the multiple records, the average price data being combined with data of transactions of tickets of the corresponding record into the record-level integrated dataset.

9. The method of claim 3, wherein the third determining module includes:
a second transceiver configured to receive a plurality of datasets from the contract transaction data sources, the plurality of datasets including at least a third dataset and a fourth dataset that are received, respectively, from different ones of the plurality of different contract transaction data sources, the third dataset including records of data of average prices for all standardized contacts since an initiation of said system and the fourth dataset including records of data of current bid and offer price for each type of standardized contract;
a second non-transitory computer readable storage medium configured to store a fourth database;
a second processing unit that includes at least one second hardware processor, the second processing unit being configured to:
store, to the fourth database, the received plurality of datasets;
generate at least one second index dataset based on the plurality of datasets; and
transmit, via the second transceiver, the generated at least one second index dataset for reception by the second calculating module.

10. The method of claim 9, wherein search of the third dataset to locate at least one record is further based on ranking a plurality of records from the third dataset according to matching criteria.

11. The method of claim 10, wherein the located at least one record in the third dataset is located based on having a highest rank according to the matching criteria.

12. The method of claim 11, wherein the matching criteria take into account one or more of the traveler route criteria.

13. The method of claim 12, wherein records in the third dataset, the fourth dataset, or both that are not matched are excluded from the second record-level integrated dataset.

14. The method of claim 13, wherein when multiple records are located in the third dataset that a corresponding record may match to, the method includes
calculating average price data based on a pricing data from each record in the multiple records, the average price data being combined with the data of transactions of contacts of the corresponding record into the second record-level integrated dataset.

15. The method of claim 1, wherein the ticket provided to the traveler is a paper ticket.

16. The method of claim 1, wherein the ticket provided to the traveler is an electronic ticket.

17. The method of claim 1, wherein the ticket provided to the traveler is a flexible ticket.

18. The method of claim 1, wherein the ticket provided to the traveler is a non-flexible ticket.
